(19) United States
(12) Patent Application Publication
(10) Pub. No.: US 2011/0276475 A1
(43) Pub. Date: Nov. 10, 2011

(54) PAYMENT TRANSACTION DISPUTE RESOLUTION SYSTEM

(76) Inventors: Cheryl Godejohn, Cedarburg, WI (US); Alan Hines, Arvada, CO (US); Marilyn Ehlers, Highlands Ranch, CO (US)

(21) Appl. No.: 13/096,744

(22) Filed: Apr. 28, 2011

Related U.S. Application Data
(60) Provisional application No. 61/331,261, filed on May 4, 2010.

(51) Int. Cl. G06Q 40/00

(52) U.S. Cl. 705/39

(57) ABSTRACT

A system, apparatus, and method for resolving disputes arising from payment transactions. Such disputes may relate to the non-performance of an obligation agreed to by a party to a transaction, or the dispute may involve an allegation that a payment transaction was fraudulent, with a chargeback being requested. The invention may be used to resolve disputes arising from payment transactions that are processed by more than one payment processor, such as for a first payment transaction that was processed by a first payment processor and a second payment transaction that was processed by a second and different payment processor.

### CROSS REFERENCE TO RELATED APPLICATIONS

This application claims priority from U.S. Provisional Patent Application No. 61/331,261, entitled “Payment Transaction Dispute Resolution System,” filed May 4, 2010, the contents of which are hereby incorporated in their entirety by reference for all purposes.

### BACKGROUND

Embodiments of the invention are directed to systems, apparatuses and methods for conducting and processing payment transactions, and more specifically, to a dispute resolution system that may be used to resolve disputes arising from payment transactions. In contrast to conventional dispute resolution systems, embodiments of the invention may be used to resolve a dispute arising from a transaction that was processed by a first payment processing organization and also to resolve a separate dispute arising from a transaction that was processed by a second and different payment processing organization. For example, in some embodiments, the invention may be used to process a request for dispute resolution services or for a chargeback for a transaction processed by Visa and to process a request for dispute resolution services or for a chargeback for a different transaction that was processed by MasterCard.

Portable consumer payment devices such as debit cards or credit cards are used by millions of people worldwide to facilitate various types of commercial transactions. In a typical transaction involving the purchase of a product or service at a merchant location, the device is presented at a point of sale terminal (“POS terminal”) located at a merchant's place of business. A consumer may also initiate a payment transaction by providing payment data from a remote location to a merchant over a network such as the Internet. Transactions of this type are typically initiated using a computing device such as a personal computer or laptop computer. Transactions may also be initiated by using a mobile device such as a cell phone or personal data assistant (PDA) that includes a payment device (such as a contactless chip) and that communicates with a merchant or service provider directly or indirectly over a wireless network.

Although the majority of payment transactions occur without any complications, in some cases either the consumer or merchant may become dissatisfied with some aspect of the transaction. Typical reasons for such dissatisfaction include the failure to deliver goods or services as promised, or an unresolved complaint regarding the goods, the services or the payment for the goods or services. Another potential source of dissatisfaction is an assertion that some aspect of the transaction was fraudulent, such as when a consumer challenges a transaction listed on their credit card bill. When such problems occur, they may lead to the initiation of a dispute between the consumer and merchant, or between another entity involved in the transaction process (e.g., an acquirer, issuer, or payment processing organization) and the consumer or merchant. When a dispute arises from a payment transaction, a consumer may request a return of the funds involved in the transaction to their account. This may be accomplished using a process termed a “chargeback”, in which the consumer contacts their issuer to file a complaint and request a reversal of the transaction.

Presently, when such disputes are initiated they are managed through a dispute resolution (DR) system, which may be part of a customer relations function for an issuer or payment processor (where the payment processor may be a payment processing organization such as Visa or MasterCard). The DR system may be partially or fully automated and may perform one or more of the functions involved in managing the dispute resolution process including collecting the required data, communicating with the parties involved, and conducting the dispute resolution process in accordance with the relevant codes, regulations, or business rules of the payment processing organization.

Typically, each entity that issues a payment device to a consumer (such as a consumer's bank or credit union) may have a separate DR system and set of rules, conditions, regulations, and processes for resolving a dispute arising from a transaction that was conducted using that issuer's payment device. Similarly, each payment processing organization (such as Visa or MasterCard) may have a separate DR system that is dedicated to resolving disputes arising from transactions processed by that payment processing organization. Further, there may be differences in the DR system or procedures followed depending upon whether the transaction was initiated using a credit card, debit card, or other form of payment device. In addition to having separate and possibly different rules, procedures, and regulations, each DR system may be accessed using a different customer care system, user interface, or other system elements. In general, each such DR system is a closed, proprietary system that does not exchange data and is not required to have common procedures with DR systems operated by parties falling outside of a specific group, affiliation, organization, or network.

Although presently used DR systems provide a desirable service for customers (e.g., issuers, consumers and merchants), the ways in which such systems are implemented do have disadvantages. For example, if an issuer provides more than one type of payment device (e.g., both Visa and MasterCard branded credit cards), then that issuer must interact with more than one DR system, each with its own set of rules and processes. This creates an administrative problem by increasing overhead and employee training requirements. In addition, it requires existing data processing and computing systems to be able to connect to and interface with the multiple DR systems, resulting in increased information systems (IS) management overhead. This may introduce additional complexity, costs and inefficiencies, not to mention potential sources of user dissatisfaction.

Thus, with multiple, separate DR systems in place, issuers, consumers, and merchants are subject to multiple sets of proprietary and/or specialized dispute resolution rules and processes. This may require each party involved in a dispute to learn and use multiple methods and systems for dispute resolution, instead of having a more unified method for the management and execution of a dispute resolution process.

In addition to disputes arising from the failure of a party to a transaction to fulfill its obligations, disputes also arise when a consumer or other party to a transaction suspects that fraud may have occurred. Given the large number of transactions and amounts of money involved, the detection and prevention of fraud is an important consideration of any payment transaction processing system. In order to report a suspected fraudulent transaction or request a “chargeback” to correct a fraudulent transfer of funds, a consumer or issuer may utilize a DR system or some functions that may be found in a DR system. Thus, some fraud reporting systems may suffer from the same disadvantages as standard DR systems (e.g., different fraud reporting systems for different issuers or different payment processing organizations, etc.). In this case a similar situation may exist with regards to submitting a request for a chargeback as with a request for dispute resolution services; an issuer may be required to interact with multiple payment processing organizations and be knowledgeable with regards to those organizations' respective interfaces, data processing systems, rules, reason codes, formatting requirements, etc.

What is desired is a dispute resolution system for use in resolving disputes arising from payment transactions that overcomes the noted disadvantages of the conventional approaches to implementing such systems, particularly in the case of an issuer that provides payment devices used to conduct payment transactions that are processed by more than a single payment processing organization.

### SUMMARY

Embodiments of the invention are directed to a system, apparatus, and method for resolving disputes arising from payment transactions. Such disputes may relate to the non-performance of an obligation agreed to by a party to a transaction, or the dispute may involve an allegation that a payment transaction was fraudulent. In some disputes, a consumer may ask that a charge be reversed leading to a chargeback being requested by an issuer. The inventive system, apparatus, and method may be used to assist in resolving disputes arising from multiple payment transactions that are processed by more than a single payment processor, such as for a first payment transaction that was processed by a first payment processor and for a second payment transaction that was processed by a second and different payment processor. In one embodiment, the first payment processor may be a first payment processing organization such as Visa, and the second payment processor may be a second payment processing organization such as MasterCard. Thus, the invention may assist an issuer of both Visa and MasterCard branded credit or debit cards to initiate a chargeback request for a transaction that used either brand of card by using a single dispute resolution system and user interface. The inventive processing platform provides a common entry point for an issuer to access the dispute resolution and chargeback processes for more than a single payment processing organization, thereby reducing the need for the issuer to learn how to utilize multiple dispute resolution systems and provide internal training and support for multiple systems.

Embodiments of the invention can assist consumers, issuers, merchants and other parties to a payment transaction to more efficiently initiate and conduct dispute resolution activities for payment transactions. In some embodiments, the invention may utilize a data processing architecture that identifies the payment processing organization responsible for processing the transaction that gave rise to the dispute and then assists in managing the dispute resolution process in accordance with the business rules, data formatting requirements, and dispute codes of that organization. In some embodiments, the invention may provide user interface or report generating functions to enable issuers to access and utilize data relating to disputes and fraud reports for payment devices that have different corresponding payment processing organizations. As one example, an issuer that provides both Visa and MasterCard branded products to consumers may use the inventive system to initiate a chargeback process for a transaction involving either type of product. This is in contrast to present systems in which a different DR system must be used for a Visa processed transaction and for a MasterCard processed transaction.

In one embodiment, the invention is directed to an apparatus for providing dispute resolution services for disputes arising from payment transactions, where the apparatus includes an electronic processor programmed to execute a set of instructions, the electronic processor operated by a first payment processing organization and a data storage device coupled to the processor and having the set of instructions stored therein, wherein when the set of instructions are executed by the processor, the apparatus provides dispute resolution services by receiving a request from an issuer of a payment device used to conduct a payment transaction, processing the request to determine a second payment processing organization responsible for processing the payment transaction, the second payment processing organization being different from the first payment processing organization operating the electronic processor, accessing a set of business rules for the second payment processing organization, applying the set of business rules to determine if the request satisfies the second payment processing organization's requirements for accepting the request, formatting the request to place the request into a format acceptable by the second payment processing organization's data processing system, and providing the request to the second payment processing organization's data processing system.

In another embodiment, the invention is directed to an apparatus for providing dispute resolution services for disputes arising from payment transactions, where the apparatus includes an electronic processor programmed to execute a set of instructions and a data storage device coupled to the processor and having the set of instructions stored therein, wherein when the set of instructions are executed by the processor, the apparatus provides dispute resolution services by receiving a first request from an issuer regarding a first payment transaction from a user interface; processing the first request to determine a first payment processing organization responsible for processing the first payment transaction; accessing a set of business rules for the first payment processing organization; applying the set of business rules for the first payment processing organization to determine if the first request satisfies the first payment processing organization's requirements for accepting the first request; if required, formatting the first request to place the first request into a format acceptable by the first payment processing organization's data processing system; providing the first request to the first payment processing organization's data processing system; receiving a second request from the issuer regarding a second payment transaction from the user interface; processing the second request to determine a second payment processing organization responsible for processing the second payment transaction, wherein the second payment processing organization is different from the first payment processing organization; accessing a set of business rules for the second payment processing organization; applying the set of business rules for the second payment processing organization to determine if the second request satisfies the second payment processing organization's requirements for accepting the second request; if required, formatting the second request to place the second request into a format acceptable by the second payment processing organization's data processing system; and providing the second request to the second payment processing organization's data processing system.

In yet another embodiment, the invention is directed a method of providing dispute resolution services for disputes arising from payment transactions, where the method includes receiving a first request from an issuer regarding a first payment transaction from a user interface; processing the first request to determine a first payment processing organization responsible for processing the first payment transaction; accessing a set of business rules for the first payment processing organization; applying the set of business rules for the first payment processing organization to determine if the first request satisfies the first payment processing organization's requirements for accepting the first request; if required, formatting the first request to place the first request into a format acceptable by the first payment processing organization's data processing system; providing the first request to the first payment processing organization's data processing system; receiving a second request from the issuer regarding a second payment transaction from the user interface; processing the second request to determine a second payment processing organization responsible for processing the second payment transaction, wherein the second payment processing organization is different from the first payment processing organization; accessing a set of business rules for the second payment processing organization; applying the set of business rules for the second payment processing organization to determine if the second request satisfies the second payment processing organization's requirements for accepting the second request; if required, formatting the second request to place the second request into a format acceptable by the second payment processing organization's data processing system; and providing the second request to the second payment processing organization's data processing system.

Other objects and advantages of the invention will be apparent to one of ordinary skill in the art upon review of the detailed description of the invention and the included figures.

### BRIEF DESCRIPTION OF THE DRAWINGS

FIG. 1 is a functional block diagram illustrating the primary functional elements of an exemplary system for conducting an electronic payment transaction and processing payment transaction data that may be used in implementing an embodiment of the invention;

FIG. 2 is a block diagram illustrating certain of the elements that may be involved in a process to initiate a request for dispute resolution or chargeback services by an issuer that issues payment devices for multiple payment processing organizations.

FIG. 3 is a block diagram illustrating certain of the component elements and processes, functions, or operations that may be implemented by those elements to provide dispute resolution and chargeback request services in accordance with an embodiment of the invention;

FIG. 4 is a flowchart illustrating a process by which a consumer may conduct a payment transaction and an issuer access the inventive system in order to submit a request for dispute resolution services or to request a chargeback in accordance with an embodiment of the invention; and

FIG. 5 is a block diagram of elements that may be present in a computer device or system configured to execute a method or process in accordance with an embodiment of the invention.

### DETAILED DESCRIPTION

Embodiments of the invention are directed to a system, apparatus, and method for resolving disputes arising from payment transactions. Such disputes may relate to the non-performance of an obligation agreed to by a party to a transaction, or the dispute may involve an allegation that a payment transaction was fraudulent. In some disputes, a consumer may ask that a charge be reversed leading to a chargeback being requested by an issuer. The inventive system, apparatus, and method may be used to assist in resolving disputes arising from multiple payment transactions that are processed by more than a single payment processor, such as for a first payment transaction that was processed by a first payment processor and for a second payment transaction that was processed by a second and different payment processor. In one embodiment, the first payment processor may be a first payment processing organization such as Visa, and the second payment processor may be a second payment processing organization such as MasterCard.

Embodiments of the invention are typically utilized by a consumer, issuer, merchant or other party in an effort to resolve a dispute or address an allegation of fraud that arose out of the conduct of a payment transaction. Thus, embodiments of the invention are typically implemented in the context of a payment transaction system, and specifically, in the context of the processing of transaction data as part of account management functions performed by an entity that is part of a payment processing network. In some embodiments, such an entity may be a payment processing organization, such as Visa, MasterCard, Discover, etc., where such an organization operates to assist in the processing of payment transactions for its members. Typically, the members of such organizations includes issuers that issue branded payment devices (i.e., Visa cards, MasterCard branded cards, etc.) to consumers. In some cases, an entity may function as both a payment processing organization and as an issuer. In a typical payment transaction, an account owner (e.g., an individual consumer) provides a payment account or payment device identifier to a merchant or service provider. The payment account or payment device identifier may be provided in the form of a portable consumer device such as a card (e.g., a magnetic stripe card or smart card with an embedded chip) accessed by a point of sale terminal or card reader, or by a contactless device embedded in a mobile device that communicates with a point of sale terminal using a suitable communications protocol or technique, or by another suitable form.

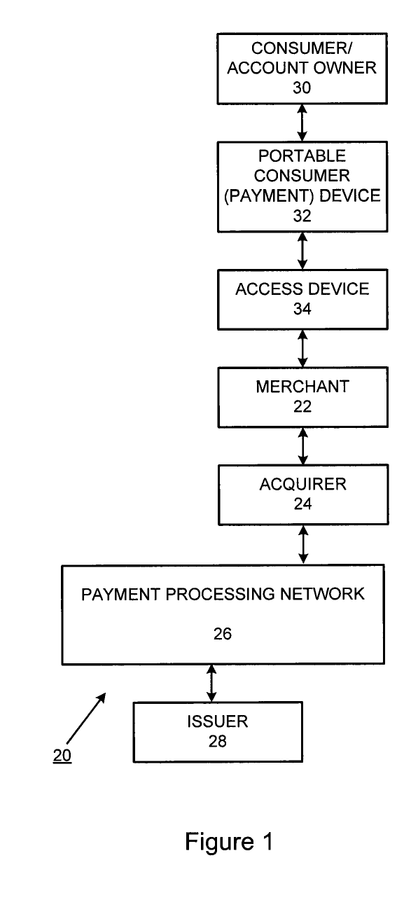

In order to provide a context in which the invention may be implemented, a brief discussion of the entities involved in processing and authorizing a payment transaction and their roles in the processing of payment transaction data will be presented. FIG. 1 is a functional block diagram illustrating the primary functional elements of an exemplary system 20 for conducting an electronic payment transaction and processing payment transaction data that may be used in implementing an embodiment of the invention. Typically, an electronic payment transaction is authorized if the consumer (typically the account owner) conducting the transaction is properly authenticated (i.e., their identity and their valid use of a payment account is verified) and if they have sufficient funds or credit to conduct the transaction. Conversely, if there are insufficient funds or credit in the account, or if the payment device is on a negative list (e.g., it is indicated as possibly having been stolen), then an electronic payment transaction may not be authorized.

In the following description, an “acquirer” is typically a business entity (e.g., a commercial bank) that has a business relationship with a particular merchant. An “issuer” is typically a business entity (e.g., a bank or credit union) which issues a portable consumer device (such as a credit card, debit card, smart card, contactless device or other form of payment device) to an account owner and which provides administrative and management functions for the payment account. Note that some entities may perform both issuer and acquirer functions. A “payment processing organization” or “payment processing network” is an organization or network that operates to assist in the processing of payment transactions for its members. The functions performed by a payment processing organization or network may include communicating transaction authorization messages between entities involved in a payment transaction (e.g., issuers and acquirers), performing functions related to authorizing a proposed transaction (e.g., determining if a proposed transaction may be fraudulent), and assisting in the clearance and settlement functions that are part of completing the processing of a transaction. Examples of payment processing organizations or networks include Visa and MasterCard.

As shown in FIG. 1, in a typical transaction, a consumer/account owner 30 wishing to purchase a good or service from a merchant provides transaction data that may be used as part of a transaction authorization process, typically by means of a portable consumer device 32, that is capable of functioning as a payment device. Account Owner 30 may utilize a portable consumer (payment) device 32 such as a card having a magnetic stripe encoded with account data or other relevant data (e.g., a standard credit or debit card) to initiate the transaction. In an eCommerce (electronic commerce) transaction, the account owner may enter data into a device capable of communicating with a merchant or other element of system 20, such as a laptop or personal computer. The account owner may also initiate the transaction using data stored in and provided from a suitable form of data storage device (such as a smart card, mobile phone or PDA containing a contactless element, or a transportable memory device). As examples, a card or similar payment device may be presented to a point of sale terminal which scans or reads data from that card. Similarly, an account owner may enter payment account data into a computing device as part of an eCommerce transaction. Further, an account owner may enter payment account data into a cell phone or other device capable of wireless communication (e.g., a laptop computer or personal digital assistant (PDA)) and have that data communicated by the device to the merchant, the merchant's data processing system, or a transaction authorization network. A wireless device may also be used to initiate a payment transaction by means of communication between a contactless element embedded within the device and a merchant device reader or point of sale terminal by using a suitable communications mechanism or protocol, such as NFC (near field communications), RF, infra-red, optical, etc. Thus, in some cases an access device 34 may be used to read, scan, or otherwise interact with a payment device and thereby obtain data used in conducting a payment transaction.

The payment account data (and if needed for processing the transaction, other account owner data) is obtained from the account owner's device and provided to the merchant 22 or to the merchant's data processing system. The merchant or merchant's data processing system generates a transaction authorization request message that may include data obtained from the payment device as well as other data related to the transaction or to the merchant. As part of generating the authorization request message, the merchant 22 or the merchant's transaction data processing system may access a database which stores data regarding the account owner, the payment device, or the account owner's transaction history with the merchant. The merchant transaction data processing system typically communicates with a merchant acquirer 24 (e.g., a commercial bank which manages the merchant's accounts) as part of the overall transaction authorization process. The merchant's transaction data processing system and/or merchant acquirer 24 provide data to Payment Processing Network 26, which participates in the authorization, clearance, and settlement processes which are part of the transaction processing. Payment Processing Network 26 may be operated in whole or in part by a payment processing organization such as Visa. As part of the transaction authorization process, an element of Payment Processing Network 26 may access an account database which contains information regarding the account owner's payment history, chargeback or dispute history, credit worthiness, etc. Payment Processing Network 26 communicates with issuer 28 as part of the authorization process, where issuer 28 is the entity that issued the payment device to the account owner and provides administrative and management services for the consumer's payment account. Account data is typically stored in an account owner database which is accessed by issuer 28 as part of the transaction authorization and account management processes.

In standard operation, an authorization request message is created during a purchase (or proposed purchase) of a good or service at a point of sale (POS). The point of sale may be a merchant's physical location or may be a virtual point of sale such as a web-site that is part of an eCommerce transaction. In a typical transaction, the authorization request message is sent from the point of sale (e.g., the merchant or the merchant's transaction data processing system) to the merchant's acquirer 24, then to the Payment Processing Network 26, and then to the appropriate issuer 28. An authorization request message can include a request for authorization to conduct an electronic payment transaction. It may include one or more of an account owner's primary account number (PAN), payment device expiration date, currency code, sale amount, merchant transaction stamp, acceptor city, acceptor state/country, etc. An authorization request message may be protected using a secure encryption method (e.g., 128-bit SSL or equivalent) in order to prevent data from being compromised.

Portable consumer (payment) device 32 may be in any suitable form and may incorporate a contactless chip or other element that facilitates payment transactions. For example, suitable payment devices can be hand-held and compact so that they can fit into a wallet and/or pocket (e.g., pocket-sized). They may include contact or contactless smart cards, credit or debit cards (typically with a magnetic stripe and without an embedded microprocessor), keychain devices (such as the Speedpass™ which is commercially available from Exxon-Mobil Corp.), and depending upon the specific device, may incorporate a contactless element that is configured to enable the device to participate in payment transactions. Other examples of suitable payment devices include cellular phones, personal digital assistants (PDAs), pagers, payment cards, security cards, access cards, smart media, transponders, and the like, where such devices may incorporate a contactless element. Depending upon the specific design, the payment device may function as one or more of a debit device (e.g., a debit card), a credit device (e.g., a credit card), or a stored value device (e.g., a stored value or prepaid card).

Payment Processing Network 26 may include data processing subsystems and networks, and may be configured to implement operations used to support and deliver authorization services, exception file services, and clearing and settlement services. An exemplary payment processing network may include VisaNet. Payment processing networks such as VisaNet are able to process credit card transactions, debit card transactions, and other types of commercial transactions. VisaNet, in particular, includes a VIP system (Visa Integrated Payments system) which processes authorization requests for transactions and a Base II system which performs clearing and settlement services for transactions. Another example of a suitable payment processing network 26 that may be used to conduct transactions that utilize embodiments of the invention is a network that is used to process payment transactions for which a MasterCard branded payment device was used.

Payment Processing Network 26 may include a server computer. A server computer is typically a powerful computer or cluster of computers. For example, the server computer can be a mainframe, a minicomputer cluster, or a group of servers functioning as a unit. In one example, a server computer may be a database server coupled to a Web server. Payment Processing Network 26 may use any suitable wired or wireless network, including the Internet, to facilitate communications and data transfer between its component system elements.

As mentioned, in some circumstances a party to a payment transaction (typically a consumer) may be unsatisfied with some aspect of a transaction and desire to initiate a dispute. The dispute may arise from a failure to fulfill some aspect of the transaction, a condition of the goods involved in the transaction, an allegation that the transaction was fraudulent, etc. As part of resolving some disputes, a consumer may request a refund of the amount spent in the transaction, or in the case of fraud, the amount involved in the transaction. In order to satisfy the consumer, the issuer of the payment device used to conduct the transaction may initiate a chargeback request, which is a formal process to attempt to reverse the funds transferred from the consumer's account (or applied as a debt owed by the consumer) to a merchant or service provider. In some cases, a merchant may also initiate a request for a service provided through a dispute resolution platform. For example, if a merchant realizes as a result of their end of day balancing process that a consumer was overcharged or double charged for service, then the merchant may initiate an ‘credit adjustment’ request using a dispute system to correct the error.

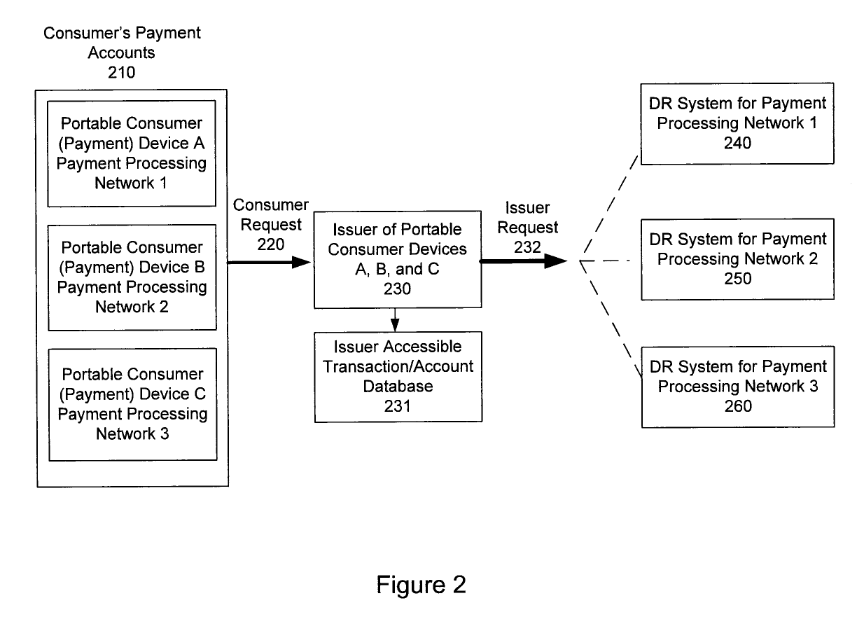

FIG. 2 is a block diagram illustrating certain of the elements that may be involved in a process to initiate a request for dispute resolution or chargeback services by an issuer that issues payment devices for multiple payment processing organizations. As shown in the figure, a consumer or account owner may use multiple portable consumer (payment) devices, with some of these devices being associated with different payment accounts. As an example, a consumer may use the payment accounts illustrated as “Consumer's Payment Accounts” 210 in the figure. This example set of payment accounts may include a first payment account associated with payment device A, a second payment account associated with payment device B, and a third payment account associated with payment device C. Further, some or all of the payment accounts may be used to conduct transactions that are processed or managed by different payment processing networks or organizations (as suggested by the indication of “Payment Processing Network 1”, “Payment Processing Network 2”, and “Payment Processing Network 3” in the figure). As an example, payment device A may be a Visa branded credit or debit card, payment device B may be a MasterCard branded credit or debit card, and payment device C may be a Discover card. For purposes of this example, assume that more than one of the payment devices were issued by a common issuer and that transactions conducted using those devices would be processed by more than one payment processing organization or network.

In the event of a dispute or suspicion of fraud in a transaction, a consumer may contact the issuer of the payment device used to conduct the transaction to initiate a dispute resolution process or request a chargeback (identified as “Consumer Request 220” in the figure). The consumer's request may be entered into a web-site operated by the issuer, communicated to a customer service representative over a phone (with or without the aid of an interactive voice response system) or via email, or provided to the issuer by any other suitable interface, method, process, or components. The issuer (identified as “Issuer of Portable Consumer Devices A, B, and C 230” in the figure) may process the consumer request to determine if further information is needed from the consumer in order to continue with the dispute resolution or chargeback request process. This may involve accessing a database that stores information and/or data relevant to accounts managed by the issuer and to transactions that were conducted using those accounts (as identified by “Issuer Accessible Transaction/Account Database 231” in the figure). The issuer may determine which payment processing network or organization is responsible for processing the transaction and then ensure that the information contained in and the format of the request satisfy the payment processing organization's requirements. Such requirements may include providing specific codes, transaction data, satisfying specific rules or conditions, etc. After the issuer ensures that the request for dispute resolution services or a chargeback is in the appropriate form and contains the appropriate information for the relevant payment processing organization, the issuer submits a request (identified as “Issuer Request 232” in the figure) to the dispute resolution (or chargeback) system for the appropriate payment processing organization (identified as “DR System for Payment Processing Network 1 240”, “DR System for Payment Processing Network 2 250”, or “DR System for Payment Processing Network 3 260” in the figure).

Note that because the issuer has issued payment devices for more than a single payment processing organization, the issuer's data processing operations must be configured to perform the operations, functions, and processes required to support multiple dispute resolution and chargeback systems. This includes customer support, IT support, data processing, request processing and formatting, employee training, and communications and data transfer functions for multiple dispute resolution systems. Many of these functions are duplicative and increase the cost of operations and the administrative overhead for the issuer.

However, as recognized by the inventors, the invention overcomes many of these problems and disadvantages of conventional disputer resolution and chargeback request systems or architectures. Specifically, in some embodiments, the invention is an architecture for a system that may be used to provide dispute resolution services or initiate a request for a chargeback for a payment transaction. The payment transaction was conducted using a payment device or payment account that was issued by an issuer. In addition to the payment device or account used for the transaction of interest, the issuer also “issued” payment devices that are used in transactions that are processed by a different payment processing organization than the payment processing organization for the transaction of interest. For example, the issuer may have issued a Visa branded credit card for the transaction of interest, but may also issue MasterCard branded credit cards.

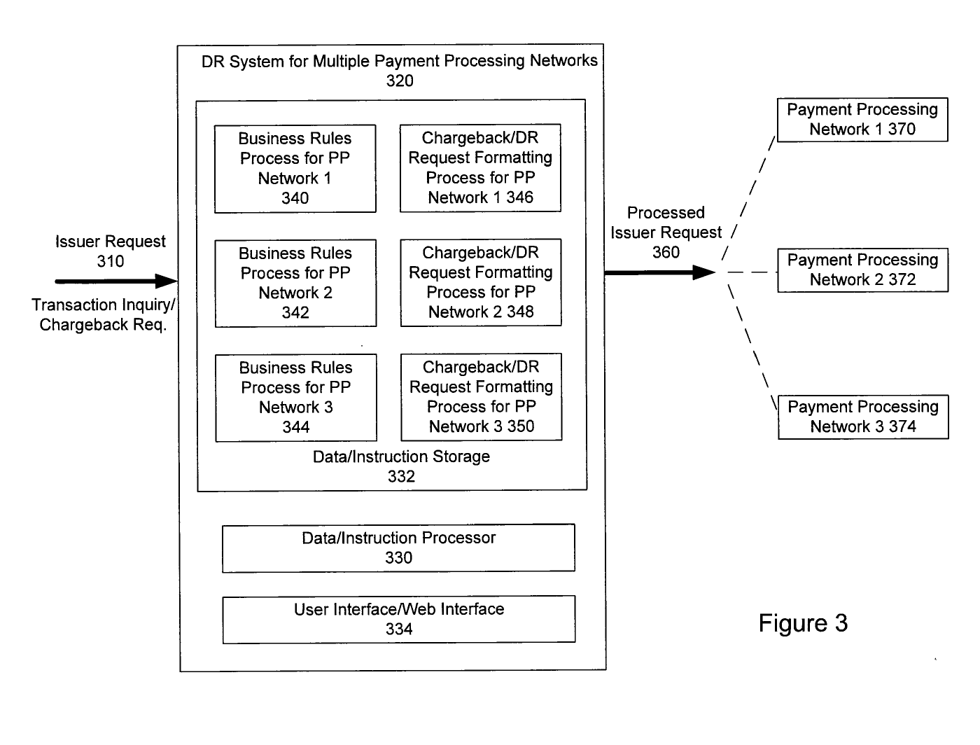

FIG. 3 is a block diagram illustrating certain of the component elements and processes, functions, or operations that may be implemented by those elements to provide dispute resolution and chargeback request services in accordance with an embodiment of the invention. In some embodiments, the elements shown in FIG. 3 are part of a system or architecture that would be used in response to a request from an issuer for dispute resolution services or a chargeback that arose from a payment transaction. The payment transaction will typically have been conducted by a consumer who had been issued multiple portable consumer (payment) devices from a common issuer (as described with reference to FIG. 2). Further, in some embodiments, the devices may be associated with more than a single payment processing organization. For example, the consumer may have been issued a Visa branded credit card and a MasterCard branded credit card by the same issuer.

Note that although FIG. 2 was described with reference to a consumer having been issued portable consumer (payment) devices corresponding to more than one payment processing organization, use of the invention is not limited to such a situation. The invention may be used by issuers that issue payment devices corresponding to more than one payment processing organization, regardless of whether a specific consumer was issued payment devices corresponding to more than one payment processing organization. Thus, the issuer request(s) that initiate the provision of dispute resolution services by the inventive system may be the result of transactions processed by more than one payment processing organization, with the transactions having been conducted by one or by more than one consumer.

As shown in FIG. 3, an issuer submits a request (identified as “Issuer Request 310” in the figure) to the inventive system (“identified as “DR System for Multiple Payment Processing Networks 320” in the figure). In some embodiments, the request is to initiate a dispute resolution (DR) process or to request a chargeback for a specific transaction. The request may be in the form of a message, code, report, form, or other suitable means of communication with the inventive system. In some embodiments, the request may be submitted to system 320 by accessing a web-page using a browser application that is executing on an issuer's computing device (such as a desktop computer, laptop computer, work station, tablet computer, etc.). In some embodiments, the request may be submitted by using an interactive voice response (IVR) system to provide responses to audio prompts and thereby submit the request and define certain parameters of the requested service. In some embodiments, the request may be submitted by means of an email or other form of message, where in response to the request message, system 320 may provide the requestor with a form to be completed or a list of information that is needed to process the request. The element identified as “User Interface/Web Interface 334” in FIG. 3 represents some or all of the elements used by an issuer to submit request 310 to system 320 in order initiate a dispute resolution process or to request a chargeback.

In some embodiments, system 320 may be operated by a payment processing organization, such as Visa. In such an embodiment, the payment processing organization is able to provide issuers with a single entry point for access to the dispute resolution and chargeback processes of more than a single payment processing organization. For example, if operated by Visa, system 320 may enable issuers to access the dispute resolution and chargeback processes for not only Visa, but also for one or more of MasterCard, Discover, or another payment processing organization. If system 320 is operated by a payment processing organization, an issuer may be provided access to the dispute resolution services and chargeback processing functions of that and other payment processing organizations by using a single, common user interface. This is in contrast to the present situation of independent DR systems in which an issuer would need to use more than a single user interface to access the dispute resolution services for transactions that were processed by more than one payment processing organization.

In some embodiments, the common interface may be the web-site or user interface elements typically used by an issuer to access the dispute resolution services and chargeback processing functions of the payment processing organization that operates the inventive system (e.g., the Visa Resolve On Line (VROL) platform). As recognized by the inventors, the invention provides issuers with a simpler and more efficient way to manage disputes or chargeback requests that arise from consumers' use of the portable consumer (payment) devices provided by the issuer. Note that in some embodiments system 320 may be operated by an entity other than a payment processing organization, such as by a third party that provides services to issuers and consumers. The issuer request(s) may be for assistance with regards to transactions processed by more than a single payment processing organization, such as for a first transaction processed by Visa and for a second transaction processed by MasterCard, and may be submitted through a single interface. In addition, the first and second transactions may have been conducted by a single consumer or by different consumers.

In some embodiments, system 320 includes a processing element, central processing unit (CPU), microprocessor, or other element operative to execute a set of instructions (identified as “Data/Instruction Processor 330” in the figure). Processor 330 is programmed with a set of instructions stored in a suitable data storage or memory (identified as “Data/Instruction Storage 332” in the figure). When the instructions are executed by the programmed processor, System 320 operates to perform one or more of the processes, operations, or methods that are part of the invention. Storage 332 may also store data that is used by Processor 330 to perform the inventive processes, operations, or methods. Such data may include information about the payment account that was used to conduct the transaction, the transaction itself, or other information relevant to the processing of the issuer request. Such other information may include business rules for the payment processing organization that was used to process transactions conducted using the payment account, formatting requirements for messages or information exchanged between System 320 and one or more payment processing organizations or networks, etc.

The executable instructions or data stored in Data/Instruction Storage 332 may include executable instructions for one or more processes, functions, operations, or methods. For example, the instructions may include instructions which, when executed, implement a process to apply one or more business rules to the issuer's request or to the underlying transaction to determine if the request satisfies the requirements of the payment processing organization or network that was responsible for processing the underlying transaction (identified as “Business Rules for PP Network 1 340” in the figure). In some embodiments, executable instructions may be stored for processes that apply business rules for multiple payment processing organizations or networks (such as those identified by “Business Rules for PP Network 2 342” and “Business Rules for PP Network 3 344” in the figure). In some embodiments, “business rules” may include rules, conditions, tests, constraints, requirements, etc. that are applied to the underlying transaction and/or to the issuer request. The “rules” are used to determine if the transaction or request satisfies the requirements that the relevant payment processing organization has placed on when it will accept a request for a dispute resolution or chargeback process. For example, the payment processing organization may require that certain data be provided as part of the request, that the underlying transaction satisfy certain criteria (e.g., that it be for a transaction amount above a certain threshold, beneath a maximum amount, that it have not been with certain merchant categories, etc.), that the payment account used for the transaction satisfy certain criteria or not have certain characteristics (e.g., that the account was not overdue by more than a certain amount of time, that the account was not previously indicated as being used in a fraudulent manner, etc.), etc.

If application of a payment processing organization's business rules indicates that additional data or information is needed to be able to initiate a request for dispute resolution services or a chargeback, then the issuer may be requested or prompted to provide that data or information. In some embodiments, if application of a payment processing organization's business rules indicates that additional data or information is needed to be able to initiate a request for dispute resolution services or a chargeback, then the inventive system may access a data storage element in which payment device and transaction data is stored in order to obtain the additional data or information.

In addition to including instructions which when executed, implement a process or processes to apply a payment processing organization's business rules as part of validating an issuer's request, Data/Instruction Storage 332 may also include executable instructions for one or more processes that format the issuer's request for dispute resolution services or for a chargeback into the proper format for presentation to the relevant payment processing organization or network (identified as “Chargeback/DR Request Formatting Process for PP Network 1 346” in the figure). In some embodiments, executable instructions may be stored for processes that apply such formatting requirements for multiple payment processing organizations or networks (such as those identified by “Chargeback/DR Request Formatting Process for PP Network 2 348” or “Chargeback/DR Request Formatting Process for PP Network 3 350” in the figure).

The formatting requirements may include the presentation of certain account or transaction related information in certain data fields, the use of certain reasons, codes or indicators to characterize the transaction, the nature of the dispute, or the reason for the issuer request, etc. In some embodiments, the request formatting process may implement an operation to map or translate dispute codes or other transaction or account related codes or reasons for one payment processing organization to the dispute codes or other transaction or account related codes or reasons for another payment processing organization. For example, in some embodiments, the inventive processes may map a code or codes that are used by Visa to describe a reason for requesting dispute resolution services or a chargeback to a code or codes used by MasterCard for those purposes. In such an embodiment, the inventive processes permit the inventive system to expand to be used with transactions processed by multiple payment processing organizations. For each new payment processing organization, a new mapping or translation process may be added to enable processing of issuer requests for services related to a transaction processed by the new organization. Further, in some cases new reasons or dispute codes may be added in order to provide a way to characterize a request or transaction for a payment processing organization in a situation where an analogous reason or dispute code does not presently exist for a different payment processing organization.

After the appropriate processing to determine if an issuer request satisfies the relevant business rules and to place the request into the proper format for the payment processing organization that processed the underlying transaction, system 320 provides the resulting output (identified as “Processed Issuer Request 360” in the figure) to the appropriate payment processing organization or network (identified as “Payment Processing Network 1 370”, “Payment Processing Network 2 372”, or “Payment Processing Network 3 374” in the figure). This may be accomplished using a direct connection from system 320 to an element of the relevant payment processing organization or by means of an intermediary communications network (such as the Internet). Note that although identified as a “Payment Processing Network in the figure, the recipient of processed and validated issuer request 360 may be a process operating within the relevant payment processing organization or network. Such a process may include a dispute resolution process, a process for intake of issuer requests, a process for requesting a chargeback, etc. Further, although FIG. 3 illustrates aspects of the inventive system as used with three payment processing organizations or networks, it is understood that these are shown for purposes of example and that a different number of such organizations may be present in other embodiments of the invention.

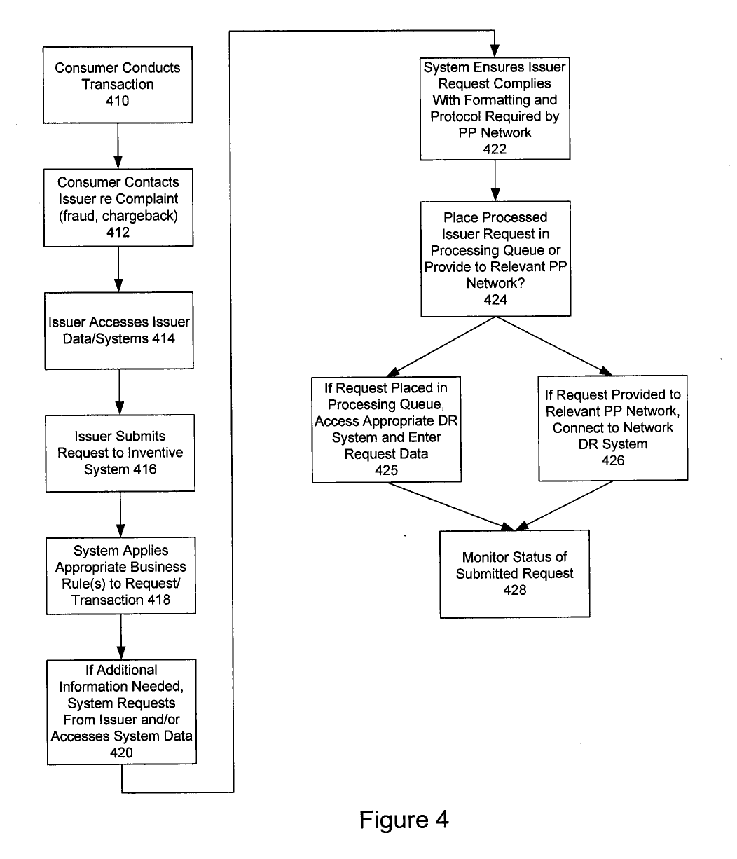

FIG. 4 is a flowchart illustrating a process by which a consumer may conduct a payment transaction and an issuer access the inventive system in order to submit a request for dispute resolution services or to request a chargeback in accordance with an embodiment of the invention. Note that certain of the process steps or functions described with reference to FIG. 4 may be implemented in the form of executable instructions or computer code for one or more of the processes described with reference to FIG. 3, for example, the Business Rules Process(es) or the Chargeback/DR Request Formatting Process(es).

As shown in the figure, use of the inventive system and related processes typically results from a consumer conducting a payment transaction using a payment device associated with the consumer (step or stage 410). As a result of dissatisfaction with the transaction, the consumer contacts the issuer of the payment device to initiate a dispute resolution process or to request a chargeback (step or stage 412). In response, the issuer may access its own data stores or systems to determine relevant information about the transaction that served as the basis for the consumer's request for dispute resolution services or a chargeback (step or stage 414). Such information may include data characterizing the transaction to enable the issuer to identify the transaction or account as needed by the inventive system for purposes of submitting a request for a dispute resolution process or chargeback. Note that in some embodiments, an issuer may use a database query or “Transaction Inquiry” function provided by the inventive system to access the system's transaction data and determine the transaction of interest (e.g., by providing an account number and perhaps a date, dates, or date range for the transaction of interest) and/or obtain further information about the transaction of interest (e.g., the amount, date, merchant category, etc.). Typically, the payment account number and date or possible dates of the transaction would be entered, and using the retrieved list of candidate transactions an issuer would be able to identify the transaction of interest by knowing the transaction amount and/or merchant involved in the transaction (either or both of which may have been provided by the consumer). Such a Transaction Inquiry function or process may be accessible to the issuer by using a browser application executing on an issuer computing device or work station to access a web-site provided by the entity operating the inventive system. An issuer may also access the Transaction Inquiry function using their own customer service systems by using a web interface that provides access to the inventive system's operations and functions.

An issuer would also typically know the payment processing organization or network that was responsible for processing the transaction. This might be known because of the issuer's knowledge of the payment processing organization or network that was associated with the payment account used to conduct the transaction (e.g., the payment device may have been a Visa branded credit card). In some embodiments, an issuer may use the previously described “Transaction Inquiry” function to access detailed information regarding the transaction and thereby determine the payment processing organization or network responsible for processing the transaction. Once the issuer has obtained the information needed to identify the transaction of interest, that information (and other information, if any, required by the inventive system) can be provided to the inventive system in the form of a request for dispute resolution services or a request for a chargeback (step or stage 416). Note that if the payment processing organization responsible for processing the transaction of interest is not provided as part of the issuer's request, then the inventive system may be able to access it by querying its own data stores or databases for transaction data.

In some embodiments, the inventive system then executes a process, operation, or function to determine if the issuer request satisfies any requirements or conditions of the relevant payment processing organization with regards to characteristics of a transaction that are required in order for the payment processing organization to accept the request (or in the alternative, characteristics of the transaction that might cause the payment processing organization to reject or refuse to accept the request). As described with reference to FIG. 3, this process, operation, or function may be characterized as application of one or more “business rules” to the issuer's request and/or to the transaction of interest (step or stage 418). As described, the business rules are used to determine if the request satisfies certain conditions, tests, constraints, requirements, etc. that are applied to the underlying transaction and/or to the issuer request. These are used to determine if the transaction or request satisfies the requirements that the relevant payment processing organization has placed on when it will accept a request for a dispute resolution or chargeback process. For example, the payment processing organization may require that certain data be provided as part of the request, that the underlying transaction satisfy certain criteria (e.g., that it be for a transaction amount above a certain threshold, beneath a maximum amount, that it have not been with certain merchant categories, etc.), that the payment account used for the transaction satisfy certain criteria or not have certain characteristics (e.g., that the account was not overdue by more than a certain amount of time, that the account was not previously indicated as being used in a fraudulent manner, etc.), etc.

If application of a payment processing organization's business rules indicates that additional data or information is needed to be able to initiate a request for dispute resolution services or for a chargeback, then the issuer may be requested or prompted to provide that data or information (step or stage 420). In some embodiments, the system may be able to obtain the requested or required information from a database or data store that it can access and that contains payment device, account, transaction and other relevant data. Note that the information or data needed to properly construct the request may depend on the payment processing organization, the type of transaction, the type of account used to conduct the transaction, the credit history or the transaction history of the account owner, among other factors.

Next the inventive system executes a process, operation, or function to determine if the issuer request is properly formatted for submission to the relevant payment processing organization (step or stage 422). If necessary, the inventive system may modify the request or the data or information contained within the request in order to comply with the relevant formatting requirements. This may include operations such as moving data to specified fields, constructing a header containing certain information or data, etc. It may also include the addition of dispute codes, reason codes, descriptions, or other indicators that are needed in order for the payment processing organization to properly process the issuer request. In some embodiments, it may include “mapping” or “translating” dispute codes, reason codes, descriptions or other indicators from those used by one payment processing organization to those used by a different payment processing organization. Note that if the inventive system is operated by a payment processing organization, then if the request from the issuer relates to a transaction that was processed by that payment processing organization, re-formatting may not be needed. However if the request relates to a transaction that was processed by a payment processing organization different from the one operating the inventive system, then the request would need to comply with any formatting, protocol, or other requirements of the other organization and may need to be changed to enable the request to be communicated to the other organization and interpreted by that organization. Note that as described, such changes may include replacing one reason or code by another as the result of a mapping operation, and also may include adding a reason or code to the request in a situation where the added reason or code is not analogous to a reason or code used by a different payment processing organization.

After ensuring that the issuer request satisfies the relevant business rules and formatting requirements of the relevant payment processing organization, the inventive system provides the processed issuer request (e.g., message 360 of FIG. 3) to the payment processing organization for the transaction. The processed request may be provided by any suitable means, communication system, network, etc. For example, the inventive system may provide the processed request to a first payment processing organization by means of a direct connection to the data processing resources of the organization, to a second payment processing organization by means of an interface (such as an API or web-service interface) between the inventive system and the data processing resources of the second organization, etc. Note that messages and/or data exchanged between the inventive system and a payment processing organization may be formatted in accordance with a standardized specification (e.g., the ISO 8583 spec) and exchanged using a standardized or required communication interface. The exchange of messages and/or data may occur using a batch mode or be provided as individual communications.

Note that in some cases, the processed issuer request may be placed into a processing queue for handling in a different manner. This may occur, for example, if the inventive system is configured to have interfaces to only certain payment processing organizations. For example, if the inventive system is operated by Visa, it may include an interface to permit communications and data transfer to Visa's dispute resolution and chargeback processing systems, and to MasterCard's dispute resolution and chargeback processing systems. But, it may lack an interface to other payment processing organization's dispute resolution and chargeback processing systems, such as the Discover card network. In cases of an issuer request for dispute resolution or chargeback processing for a transaction processed by a payment processing organization or network for which such an interface is lacking, in some embodiments, the inventive system may route the processed issuer request to a processing or special handling queue. Such a queue may take the form of a data storage element, list, database, directory, file, or other suitable form. Once placed into the processing or special handling queue, the issuer request may be processed by a customer service representative who reviews the request and accesses the dispute resolution or chargeback processing mechanisms for the appropriate payment processing organization (via a browser and appropriate web-site, for example) and may manually enter the information needed to initiate the desired action.

Thus, in some embodiments, the inventive system may execute a process, operation, or function to determine if a processed issuer request should be provided to a particular payment processing organization or network, or instead should be routed to a processing queue for further handling (as suggested by step or stage 424). As noted, this may depend upon the payment processing organizations or networks which the inventive system has been configured to have access to for purposes of transferring data and messages. For those payment processing organizations or networks which the inventive system has been configured to have access to, the system performs what processes are needed to connect to the payment processing network's dispute resolution system (or an interface to such a system) and provides the processed issuer request to the dispute resolution system (as suggested by step or stage 426). This may mean, for example, accessing an appropriate API, storing the request in a specific format and sending it as payload to an access point for the dispute resolution system, calling a subroutine that interfaces with the dispute resolution system, etc. If instead, the processed issuer request should be routed to a processing queue for further handling, then the inventive system performs this action and may generate a notification to an appropriate system or person. This would be followed by a customer service representative accessing the issuer request and providing the relevant data or information to the appropriate dispute resolution or chargeback processing system (as suggested by step or stage 425). This may be accomplished by navigating to an appropriate web-site using a browser application, submitting information using an IVR system, providing information in the form of a payload attached to a message, or by another suitable method. After the processed issuer request is provided to the appropriate payment processing organization or network, the inventive system may monitor the status of the request in order to provide information regarding the current state of any request (as suggested by step or stage 428).

Note that in some embodiments, some or all of the business rules and formatting processes may not be applied to a request automatically if the underlying transaction was processed by a payment processing organization for which further handling would be required. In such cases, application of the business rules and/or the formatting operations may be performed by a customer service representative as part of preparing the request for submission to the appropriate dispute resolution or chargeback processing system. In such cases, the inventive system may determine the payment processing organization responsible for processing the transaction of interest, and then decide whether to apply the relevant business rules and formatting requirements, or instead route the request to a queue for processing by a customer service representative.

In some embodiments, the inventive methods, processes or operations for processing an issuer request for dispute resolution services or to initiate a chargeback process may be wholly or partially implemented in the form of a set of instructions executed by a programmed central processing unit (CPU) or microprocessor. The CPU or microprocessor may be incorporated in an apparatus, server or other computing device operated by, or in communication with, a payment processing organization or other entity (such as depicted as element 330 in FIG. 3). In some embodiments, the apparatus, server or other computing device may be part of a dispute resolution platform operated by a payment processing organization.

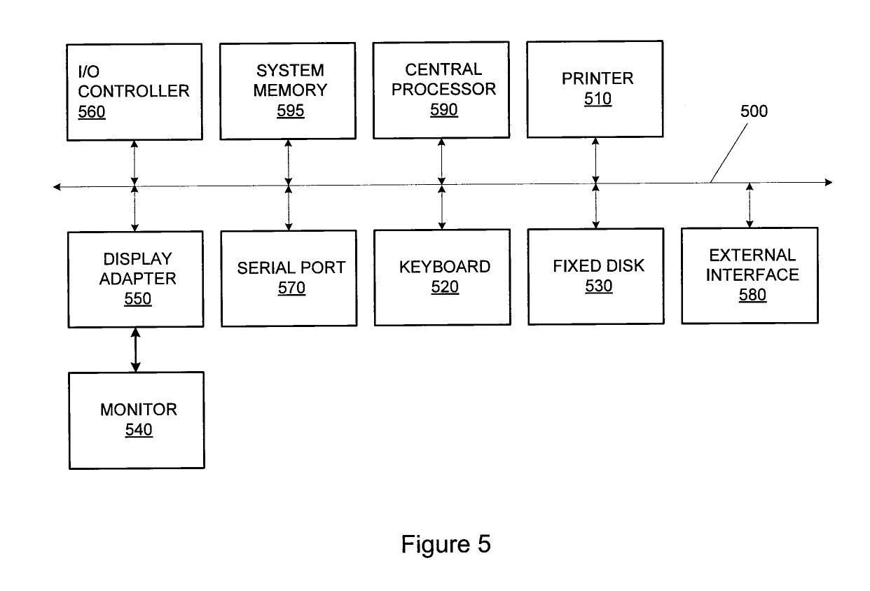

As an example, FIG. 5 is a block diagram of elements that may be present in a computer device or system configured to execute a method or process in accordance with an embodiment of the invention. The subsystems shown in FIG. 5 are interconnected via a system bus 500. Additional subsystems such as a printer 510, a keyboard 520, a fixed disk 530, a monitor 540, which is coupled to a display adapter 550, and others are shown. Peripherals and input/output (I/O) devices, which couple to an I/O controller 560, can be connected to the computer system by any number of means known in the art, such as a serial port 570. For example, the serial port 570 or an external interface 580 can be used to connect the computer apparatus to a wide area network such as the Internet, a mouse input device, or a scanner. The interconnection via the system bus 500 allows a central processor 590 to communicate with each subsystem and to control the execution of instructions that may be stored in a system memory 595 or the fixed disk 530, as well as the exchange of information between subsystems. The system memory 595 and/or the fixed disk 530 may embody a computer readable medium.

As has been described, the inventive system and associated methods, operations, functions, and processes provide an issuer with a more efficient way to access transaction data and submit a request for dispute resolution services or to initiate a chargeback process for a transaction. The invention is particularly (although not exclusively) advantageous for issuers who issue payment devices for more than one payment processing organization or network (e.g., both Visa and MasterCard branded credit cards). For such issuers, the invention provides a single user interface or point of entry to request dispute resolution or chargeback processing for a transaction that was conducted using a portable consumer (payment) device issued by the issuer, where the device may be associated with one of several payment processing organizations. This provides an issuer with an easier and less administratively burdensome way to manage disputes and chargebacks for devices associated with multiple payment processing organizations. For example, the invention allows an issuer of both Visa and MasterCard branded payment devices (e.g., credit, debit, or prepaid cards) to request dispute resolution services or chargeback processing without the burden of accessing multiple dispute resolution systems or having to learn how to format or prepare requests for multiple systems.

As noted, in some embodiments, the inventive system may be operated by a payment processing organization, such as Visa. In such situations, an issuer, merchant, or other party may access the inventive system by accessing a web-site, web service, or other suitable entry point and then interact with the system to prepare and submit a request. In some embodiments, the entry point may be a dispute resolution system operated by the payment processing organization, which incorporates or is configured to interact with the inventive system.

It should be understood that the invention as described above can be implemented in the form of control logic using computer software in a modular or integrated manner. Based on the disclosure and teachings provided herein, a person of ordinary skill in the art will know and appreciate other ways and/or methods to implement the invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. An apparatus for providing dispute resolution services for disputes arising from payment transactions, comprising:
an electronic processor programmed to execute a set of instructions, the electronic processor operated by a first payment processing organization; and
a data storage device coupled to the processor and having the set of instructions stored therein, wherein when the set of instructions are executed by the processor, the apparatus provides dispute resolution services by
receiving a request from an issuer of a payment device used to conduct a payment transaction;
processing the request to determine a second payment processing organization responsible for processing the payment transaction, the second payment processing organization being different from the first payment processing organization operating the electronic processor;
accessing a set of business rules for the second payment processing organization;
applying the set of business rules to determine if the request satisfies the second payment processing organization's requirements for accepting the request;
formatting the request to place the request into a format acceptable by the second payment processing organization's data processing system; and
providing the request to the second payment processing organization's data processing system.

2. The apparatus of claim 1, wherein the apparatus provides dispute resolution services by requesting information from the issuer in order to determine if the request satisfies the second payment processing organization's requirements for accepting the request.

3. The apparatus of claim 1, wherein the apparatus provides dispute resolution services by accessing a data storage device containing payment device or payment transaction data in order to determine if the request satisfies the second payment processing organization's requirements for accepting the request.

4. The apparatus of claim 1, wherein the request is for a chargeback related to the payment transaction.

5. The apparatus of claim 1, wherein formatting the request to place the request into a format acceptable by the second payment processing organization's data processing system further comprises modifying the request to include a descriptive code for an aspect of the payment transaction or the payment device, the descriptive code not being one used by the first payment processing organization.

6. The apparatus of claim 1, wherein the apparatus provides dispute resolution services by placing the request into a processing queue for manual processing by a customer service representative if the payment processing organization responsible for processing the payment transaction is a third payment processing organization different from the first or the second payment processing organizations.

7. The apparatus of claim 1, wherein the set of business rules for the second payment processing organization include criteria that the payment transaction must satisfy in order for the request to be accepted by the second payment processing organization.

8. An apparatus for providing dispute resolution services for disputes arising from payment transactions, comprising:
an electronic processor programmed to execute a set of instructions; and
a data storage device coupled to the processor and having the set of instructions stored therein, wherein when the set of instructions are executed by the processor, the apparatus provides dispute resolution services by
receiving a first request from an issuer regarding a first payment transaction from a user interface;
processing the first request to determine a first payment processing organization responsible for processing the first payment transaction;
accessing a set of business rules for the first payment processing organization;
applying the set of business rules for the first payment processing organization to determine if the first request satisfies the first payment processing organization's requirements for accepting the first request;
if required, formatting the first request to place the first request into a format acceptable by the first payment processing organization's data processing system;
providing the first request to the first payment processing organization's data processing system;
receiving a second request from the issuer regarding a second payment transaction from the user interface;
processing the second request to determine a second payment processing organization responsible for processing the second payment transaction, wherein the second payment processing organization is different from the first payment processing organization;
accessing a set of business rules for the second payment processing organization;
applying the set of business rules for the second payment processing organization to determine if the second request satisfies the second payment processing organization's requirements for accepting the second request;
if required, formatting the second request to place the second request into a format acceptable by the second payment processing organization's data processing system; and
providing the second request to the second payment processing organization's data processing system.

9. The apparatus of claim 8, wherein the apparatus provides dispute resolution services by requesting information from the issuer in order to determine if the first request satisfies the first payment processing organization's requirements for accepting the first request.

10. The apparatus of claim 8, wherein the apparatus provides dispute resolution services by accessing a data storage device containing payment device or payment transaction data in order to determine if the first request satisfies the first payment processing organization's requirements for accepting the first request.

11. The apparatus of claim 8, wherein the first request is for a chargeback related to the first payment transaction.

12. The apparatus of claim 8, wherein the apparatus provides dispute resolution services by:
instead of accessing and applying a set of business rules for the second payment processing organization, the second request is placed into a processing queue for manual processing by a customer service representative.

13. The apparatus of claim 8, wherein the set of business rules for the first payment processing organization include criteria that the first payment transaction must satisfy in order for the first request to be accepted by the first payment processing organization.

14. A method of providing dispute resolution services for disputes arising from payment transactions, comprising:
receiving a first request from an issuer regarding a first payment transaction from a user interface;
processing the first request to determine a first payment processing organization responsible for processing the first payment transaction;
accessing a set of business rules for the first payment processing organization;
applying the set of business rules for the first payment processing organization to determine if the first request satisfies the first payment processing organization's requirements for accepting the first request;
if required, formatting the first request to place the first request into a format acceptable by the first payment processing organization's data processing system;
providing the first request to the first payment processing organization's data processing system;
receiving a second request from the issuer regarding a second payment transaction from the user interface;
processing the second request to determine a second payment processing organization responsible for processing the second payment transaction, wherein the second payment processing organization is different from the first payment processing organization;
accessing a set of business rules for the second payment processing organization;
applying the set of business rules for the second payment processing organization to determine if the second request satisfies the second payment processing organization's requirements for accepting the second request;
if required, formatting the second request to place the second request into a format acceptable by the second payment processing organization's data processing system; and
providing the second request to the second payment processing organization's data processing system.

15. The method of claim 14, wherein the steps of the method are implemented by the first payment processing organization.

16. The method of claim 14, further comprising requesting information from the issuer in order to determine if the first request satisfies the first payment processing organization's requirements for accepting the first request.

17. The method of claim 14, further comprising accessing a data storage device containing payment device or payment transaction data in order to determine if the first request satisfies the first payment processing organization's requirements for accepting the first request.

18. The method of claim 14, wherein the first request is for a chargeback related to the first payment transaction.

19. The method of claim 14, wherein the method further comprises:
instead of accessing and applying a set of business rules for the second payment processing organization, placing the second request into a processing queue for manual processing by a customer service representative.

20. The method of claim 14, wherein the set of business rules for the first payment processing organization include criteria that the first payment transaction must satisfy in order for the first request to be accepted by the first payment processing organization.
